(19) United States
(12) Patent Application Publication
(10) Pub. No.: US 2023/0116967 A1
(43) Pub. Date: Apr. 20, 2023

(54) SYSTEM ARCHITECTURES FOR BIG DATA PROCESSING

(71) Applicant: The Trustees of the University of Pennsylvania, Philadelphia, PA (US)

(72) Inventors: Jing Li, Philadelphia, PA (US); Jialiang Zhang, Philadelphia, PA (US)

(21) Appl. No.: 17/885,243

(22) Filed: Aug. 10, 2022

Related U.S. Application Data
(60) Provisional application No. 63/231,636, filed on Aug. 10, 2021.
(60) Provisional application No. 63/231,632, filed on Aug. 10, 2021.
(60) Provisional application No. 63/231,512, filed on Aug. 10, 2021.

(51) Int. Cl. G06F 9/50; G06F 9/30; G06F 9/48

(52) U.S. Cl. CPC G06F 9/5022; G06F 9/4881; G06F 9/5016; G06F 9/30043; G06F 2209/501

(57) ABSTRACT

Provided are systems and methods for big data processing and related architectures. Various embodiments include a configurable load store unit, a computational register file, and related methods, systems, and devices. Requests to utilize at least one of a memory and a storage can be received at a computing system comprising a local memory and local storage. Systems and methods can determine availability of a remote memory and a remote storage at one or more remote nodes accessible by the computing system, determine a distribution among the local memory, local storage, and one or more remote nodes to fulfill the request, and based on the determination, utilize at least one of: a memory associated with a first set of one or more remote nodes via a first interconnect, and a storage associated with a second set of one or more remote nodes via a second interconnect.

### CROSS-REFERENCE TO RELATED APPLICATIONS

This application claims benefit under 35 U.S.C. §119(e) of Provisional U.S. Pat. Application No. 63/231,512, filed Aug. 10, 2021, Provisional U.S. Pat. Application No. 63/231,632, filed Aug. 10, 2021, and Provisional U.S. Pat. Application No. 63/231,636, filed Aug. 10, 2021. the contents of which are each incorporated herein by reference in their entirety.

### BACKGROUND

Computing systems continue to require increasingly powerful processors and efficient memory subsystems. Processing big data sets, for example, requires search engines and/or processors capable of performing an extremely high throughput of data sorting and processing.

Current computer architecture is designed for computation. As such, they face challenges in processing extremely large data sets, such as those used in natural language processing, searching, and machine learning. Big data applications require a high throughput (e.g., >1 billion pieces of data) which uses significant processing time and energy. Executing big data applications like search engines on a general-purpose processor can therefore be extremely expensive and time inefficient.

A conventional register file may be accessed using typical read/write operations . However, if a processing unit has a complex series of operations, then the processing unit may be required to make multiple calls to the register file to implement the operations. Thus, there are needs for significant improvements to address big data processing challenges.

### SUMMARY

To address the challenges of large data processing, the present disclosure describes systems and methods to provide scalable storage bandwidth and capacity. The present invention relates to a dynamically composable computing system comprising a computing fabric with a plurality of different disaggregated computing hardware resources having respective hardware characteristics. In embodiments, a resource manager has access to the respective hardware characteristics of the different disaggregated computing hardware resources and is configured to assemble a composite computing node by selecting one or more disaggregated computing hardware resources with respective hardware characteristics meeting requirements of an application to be executed on the composite computing node. An orchestrator can be configured to schedule the application using the assembled composite computing node.

In various embodiments, methods comprise receiving a request to utilize at least one of a memory and a storage, wherein the request is received at a computing system comprising a local memory and local storage: determining availability of a remote memory and a remote storage at one or more remote nodes accessible by the computing system; determining a distribution among the local memory, local storage, and one or more remote nodes to fulfill the request; and based on the determination, utilizing at least one of: a memory associated with a first set of one or more remote nodes via a first interconnect; a storage associated with a second set of one or more remote nodes via a second interconnect. Embodiments can further comprise disaggregating the local memory from the at least one processing unit using the first interconnect: and disaggregating the local storage from the at least one processing unit using the second interconnect.

Systems in accordance with embodiments can comprise at least one processing unit, a local memory, a local storage, a first interconnect configured to access a remote memory at a first set of one or more remote nodes, a second interconnect configured to access a remote storage at a second set of one or more remote nodes. In embodiments, the at least one processing unit is one or more of an Intelligence Processing Unit (IPU) and Central Processing Unit (CPU). The first interconnect can be a storage interconnect and the second interconnect is a memory interconnect.

In some embodiments, the first set of one or more remote nodes utilizes an RDMA network. The second set of one or more remote nodes utilizes a Peripheral Component Interconnect Express (PCIe) network, wherein at least one of a soft PCIe switch and a hard PCIe switch enables access to the second set of the one or more remote nodes. Moreover, systems and methods can utilize at least one of the local memory and the local storage to fulfill the request, wherein the request comprises access to at least one of a local memory and a local storage via a primary processing unit. In some examples, the local memory and the local storage are disaggregated into a Field Programmable Gate Array (FPGA)-independent storage and memory.

A configurable load store unit and related methods, systems, and devices are disclosed herein. An example method may comprise receiving, by an execution unit of a processor, an instruction to one or more of load data or store data. The method may comprise determining a configuration identifier associated with the instruction. The method may comprise determining, based on a configuration table and the configuration identifier, one or more configuration attributes. The method may comprise scheduling, based on the one or more configuration attributes, timing of performing the instruction.

An example device may comprise an instruction dispatcher configured to send an instruction to one or more of load data or store data. The example device may comprise an execution unit comprising a configuration table and a scheduler. The execution unit may be configured to: receive the instruction, determine a configuration identifier associated with the instruction, and determine, based on the configuration table and the configuration identifier, one or more configuration attributes. The execution unit may be configured to schedule, via the scheduler and based on the one or more configuration attributes, timing of performing the instruction. The device may comprise a register file configured to receive, based on at least the instruction, a request to perform a memory operation.

A computational register file and related methods, systems, and devices are disclosed herein. An example method may comprise generating, by a processing unit, an instruction for a register file (e.g., or computational register file) associated with the processing unit. The method may comprise sending the instruction to a first port of the register file. The method may comprise performing, based on the instruction and logic associated with the first port, a plurality of operations. The method may comprise causing, based on one or more results of the plurality of operations, an update to the register file.

An example computational register file may comprise a plurality of input ports (e.g., read ports, write ports, read/write ports) comprising a first input port and a second input port. The computational register file may comprise a plurality of logic units comprising a first logic unit and a second logic unit. The first logic unit may be communicatively coupled to the first input port and configured to perform a first plurality of operations. The second logic unit may be communicatively coupled to the second input port. The computational register file may comprise a register file communicatively coupled to the plurality of logic units.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 illustrates an example computing architecture for embodiments discussed herein.

FIG. 2 illustrates an example architecture to control memory and storage, in accordance with embodiments discussed herein.

FIG. 3 illustrates an example memory and storage architecture, in accordance with embodiments discussed herein.

FIG. 4 illustrates an example architecture for memory and storage operations, in accordance with embodiments discussed herein.

FIG. 5 illustrates an example method for memory and storage operations, in accordance with embodiments discussed herein.

FIG. 6 illustrates an example process of a load store unit.

FIG. 7 illustrates an example of memory coalescing.

FIG. 8 illustrates an example configurable load store unit in accordance with the present disclosure.

FIG. 9 illustrates an example configuration table.

FIG. 10 illustrates an example process of a configurable load store unit.

FIG. 11 illustrates an example register file.

FIG. 12 illustrates an example computational register file as disclosed herein.

FIG. 13 illustrates implementation of a priority queue using a register file.

FIG. 14 illustrates implementation of a priority queue using a register file.

FIG. 15 illustrates implementation of a priority queue using a computation register file.

FIG. 16 illustrates implementation of priority queue using a computation register file.

FIG. 17 illustrates a diagram of an example instruction for the computational register file.

FIG. 18 illustrates an example process for implementing a service.

FIG. 19 illustrates a block diagram illustrating an example computing device.

### DETAILED DESCRIPTION OF ILLUSTRATIVE EMBODIMENTS

The present disclosure can be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

The present invention provides improved systems and methods to process large volumes of data. Embodiments of the present invention utilize a unique architecture to reduce computational load, and decrease demand on the local storage, memory and processor. In embodiments, the present invention reduces the data access overhead between hardware accelerator and memory/storage in a computer system, e.g., by bypassing the CPU. Embodiments of the present invention reconfigure memory and storage architectures to offload those functions away from the CPU and IPUs through a set of interconnects.

In addition, the present invention allows a redistribution of memory, dependent on bandwidth and computational demands. For example, when a ratio of CPU to Memory is fixed, the present invention can overcome such limitations and redistribute resources as needed. By offloading memory and storage from the CPU and the IPU, the present invention provides unique ability to handle larger data sets, reduce latency, enable adaptation to accommodate different index algorithm schemes and different index sizes, and address multiple users in cloud environment more efficiently, among other benefits.

Embodiments further improve bandwidth scalability of memory/storage resources in a computer system and eliminate traditional limitations of handling large data sets in current computer systems. In experiments, the present invention can improve storage and memory bandwidth more than 8x greater than conventional computing systems and architecture.

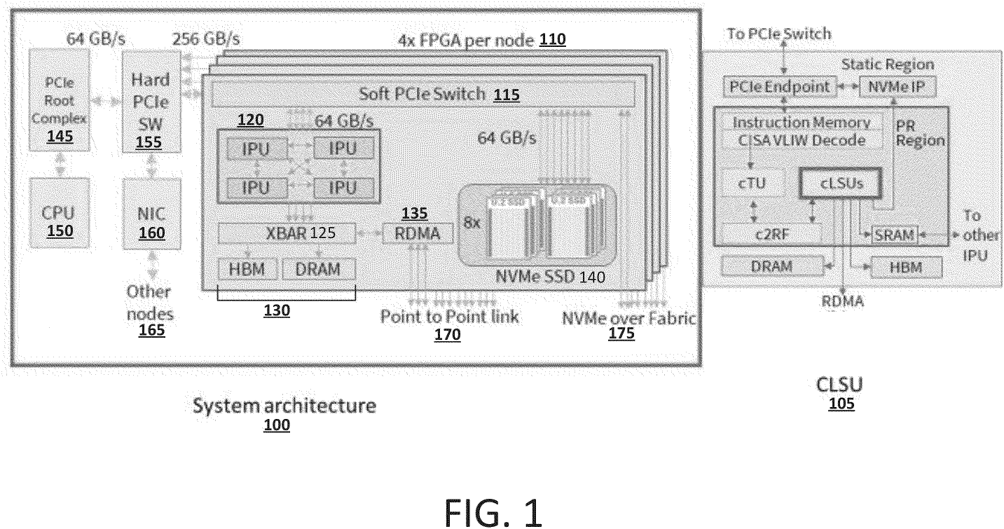

Turning to FIGS. 1-5, it will be appreciated that the following acronyms will be used to discuss various aspects of the present invention:
IPU = Intelligence Processing Unit
CPU = Central Processing Unit
RDMA = Remote Device Memory Access
NIC = Network Interface Controller
PCIe = Peripheral Component Interconnect Express
NVME = Non-Volatile Memory
DDR = Double Data Rate Random-Access Memory
HBM = High Bandwidth Memory Random-Access Memory
DRAM = Dynamic Random-Access Memory
SRAM = Static Random-Access Memory
SSD = Solid State Drive

FIG. 1 illustrates an example computing architecture applicable to embodiments discussed herein. For example, FIG. 1 illustrates an example system for implementing a configurable load store unit and/or a computational register file. The example system may comprise one or more computing nodes. A computing node may be a device, server blade, server rack, and/or the like. A node may comprise one or more computing chips, such as programmable chips.

Each computing chip may comprise, for example, a field programmable gate array. The system architecture may comprise FPGA chips 110, configured, for example, at 4 FPGA chips per node. Embodiments may have more or less FPGA chips depending on the particular computing system and requirements. The FPGA chips can comprise a Soft PCIe switch, a set of 4 IPUs, e.g., 4 IPUs, operating at a speed, e.g., 64 GB/s. The IPUs 120 communicate with XBAR 125, which functions with the HBM and DRAM 130, and RDMA 135. The RDMA 135 can be configured to communicate with a Point-to-Point Link 170 external to the FPGA. The Soft PCIe switch 115 additionally communicates with the memory, such as NVMe SSD 140. In embodiments, the speed can be 64 GB/s or another speed similar or difference to the Soft PCIe Switch’s speed with the set of IPUs 120. Embodiments can comprise a plurality of storages, such as 8 NVMe SSDs. The Soft PCIe Switch 115 is further linked to NVMe over Fabric 175.

The FPGA chips 110 can be configured to communicate with an external Hard PCIe Switch 155, further connected to a PCIe Root Complex 145 and NIC 160. Speeds between the FPGA and Hard PCIe Switch can be 256 GB/s in examples, and the communication between the Hard PCIe Switch 155 and the PCIe Root Complex 145 can be 64 GB/s, The PCIe Root Complex 145 is connected to the CPU 150. In various embodiments, it will be appreciated that the speeds listed herein can vary based on computational demand, component types, particular hardware configurations, the like.

An example implementation may include four computing chips per node, but any number may be used as appropriate. A variety of components are shown, such as a Peripheral Component Interconnect Express (PCIe) Root Complex, central processor unit (CPU). Hard PCIe switch, network interface controller (NIC), soft PCI switch, solid state drives, crossbar (XBAR) switch, Remote Direct Memory Access (RDMA), DRM, high bandwidth memory (HBM), and one or more intelligence processing units (IPU). The configurable load store unit may be comprised in at least one of the one or more IPUs. It should be noted, however, the configurable load store unit is not limited to this system and may be implemented in any processor, such as a central processing unit (CPU), graphics processing unit (GPU), Application-specific instruction set processor (ASIP), physics processing unit (PPU), digital signal processor (DSP), image processor, coprocessor, floating-point unit, network process, multi-core processor, and/or the like.

FIG. 1 further shows an example processing unit (e.g., IPU) for implementing a configurable load store unit in accordance with the present disclosure. The system architecture 100 may comprise a configurable load store unit (cLSU) 105 having any of the features disclosed herein, such as a PR region and a Static Region. The Static Region can comprise a PCIe Endpoint in communication with a NVMe IP. The PR Region can comprise an Instruction Memory, CSA, VLIW Decode. CTU, CLSUs, C2RF, and SRAM configured as shown in FIG. 1. The CLSUs can connect with the C2RF, SRAM, a DRAM and HBM in the Static region, and to an external RDMA. The CLSU 105 provides for connections to other IPUs and to a PCIe Switch.

The processing unit may further comprise a variety of additional components, such as a coding tree unit (cTU), computational register file (cRF), DRAM IP, XBAR, HBM IP, SRAM, cISA VLIW Decode, Instruction memory, PCIe Endpoint, NVMeI IP, and/or the like. The components of the processing unit may comprise a programmable region (e.g., FPGA PR region) and/or a static region (e.g., non-programmable region, FPGA static region). The configurable load store unit may be in the programmable region.

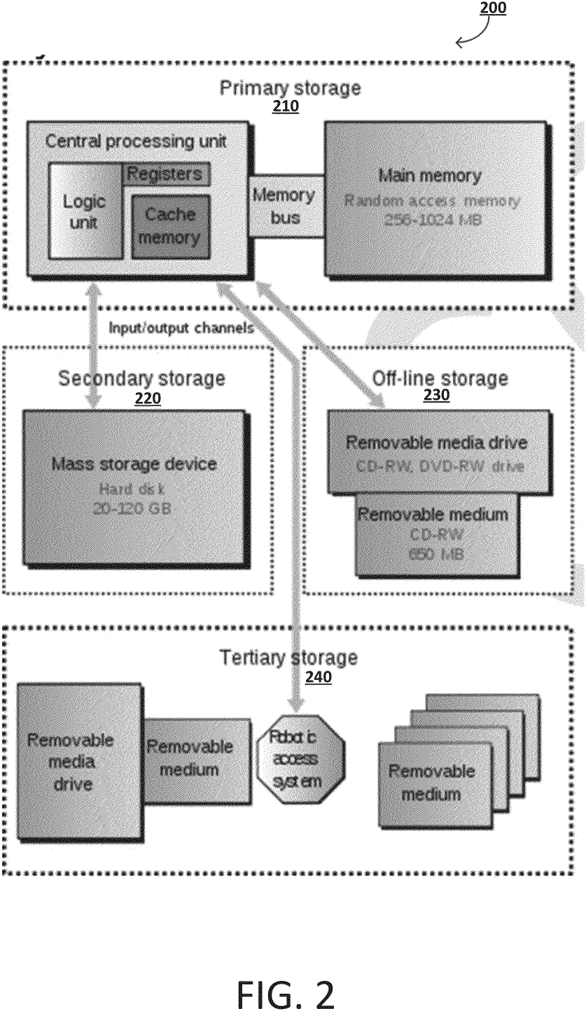

FIG. 2 illustrates an example architecture 200 to control energy and storage in accordance with embodiments discussed herein. A primary storage 210 can comprise a Central Processing Unit and a Main memory connected by a memory bus. In embodiments, the CPU can comprise a logic unit, registers, and cache memory. The main memory can comprise RAM having 256-1024 MB.

The CPU links to a secondary storage 220, a tertiary storage 240, and an offline storage 230. The secondary storage 220 can comprise a mass storage device, such as a hard disk. In various embodiments, the hard disk can be 20-120 GB. The tertiary storage 340 can comprise a removable media drive, a removable medium, a robotic access system linked to the CPU, and a removable medium. The off-line storage 230 comprises a removable media drive, such a CD-RW drive and/or a DVD-RW drive, and a removable medium, such as a CD-RW, or a 650 MB CD-RW.

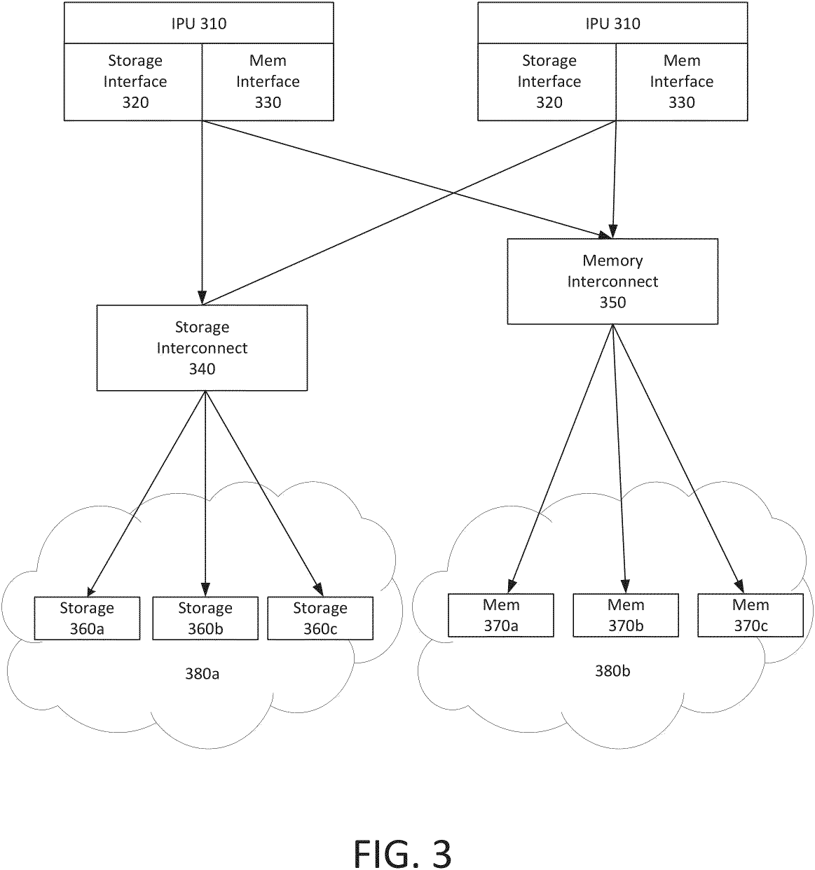

FIG. 3 illustrates the storage and memory architecture in accordance with embodiments. Key aspects of the present invention comprise a set of interconnections. The storage interconnect 340 and memory interconnect 350 allow IPUs 310 to be disaggregated logically into an FPGA-independent storage pool and memory pool. The logical disaggregation of IPU and storage/memory resources enables rebalancing the subscription between IPU and storage/memory resources and supporting indices that cannot fit into local storages and memories.

In the depicted embodiment, each IPU 310 comprises a storage interface 320 and a memory interface 330. Each respective interface can connect to a storage interconnect 340 and a memory interconnect 350.

The storage interconnect 340 can be linked to external storages 360a-c, which can be hosted on and/or accessible by a cloud network 380a. Similarly, the memory interconnect 350 can be linked to external memories 370a-c, which can be hosted on and/or accessible by a second cloud network 380b. In this manner, the computing system can utilize external storages and memories to satisfy memory and storage demands.

In various embodiments, interconnects can utilize PCIe networks for storage and RDMA network for memory PCIe network can comprise a soft PCIe switch inside each FPGA, a hard PCIe switch on the motherboard, and remote PCIe links over fabric. (See also FIG. 1). The PCIe network enables FPGA to have direct access to both local and remote NVMe SSDs with high bandwidth and ultra-low latency and alleviates the CPU bottleneck in both software (e.g., OS stack) and hardware (e.g., limited bandwidth of PCIe Root Complex). The soft PCIe switch inside the FPGA allows each IPU to directly access multiple local U2 NVMe SSDs via P2P PCIe link without interacting with host. By removing the OS stack from the SSD access path, it achieves 15 us latency. 100x lower than CPU-based systems. For our 2U node with four FPGAs, it can provide 8x higher aggregated SSD bandwidth (160 GB/s) than conventional CPU servers that need to route all PCIe traffic to the CPU’s PCIe Root Complex. In addition, the IPU can access the remote NVMe SSDs in the same node via the hard PCIe switch and NVMe SSDs in remote nodes using NVMe over fabric with 47us latency.

Similar to the storage (PCIe) network, the memory network is used to serve the memory request to both local and remote memory. Compared to the storage (PCIe) network, the memory network (RDMA) uses point to point connection instead of the switch-based network for lower latency. In addition, the memory network is hidden from the CPU. To access the content in the memory, the CPU needs to communicate with the IPU via the PCIE interface.

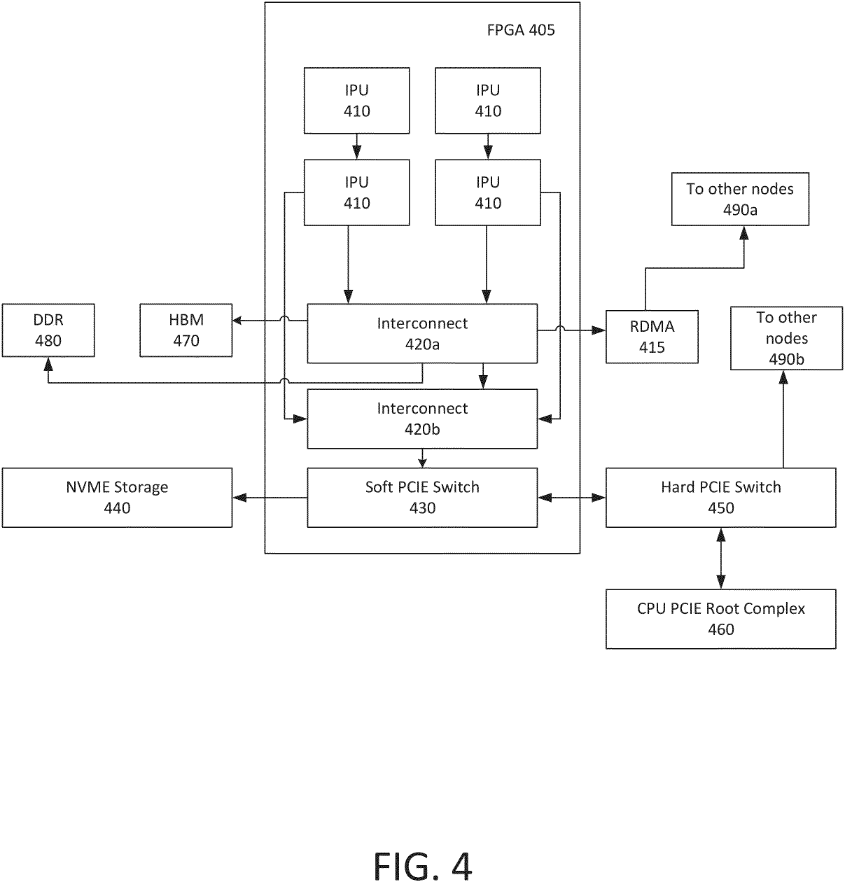

FIG. 4 illustrates an example hardware architecture for embodiments of the present invention. The present architecture includes a chip, e.g., a Field Programmable Gate Array (FPGA) chip 405. in which interconnects are used to decouple the memory and storage of the chip from local control.

A first interconnect 420a of the chip allows the local memory of the chip to be used by other nodes and allows for access to memory of other nodes. In an example the first interconnect 420a can access HBM 470, DDR 480, and RDMA 415. RDMA 415 provides access to other nodes 490a.

A second interconnect 420b of the chip 405 allows the local storage of the chip to be used by other nodes and allows for access to storage of other nodes 490b. In particular, the second interconnect can connect to a Soft PCIe Switch 430, connected to NVME 440 and a Hard PCIe Switch 450. The Hard PCIe Switch 450 can connect to other nodes 490b and/or a CPU PCIe Root Complex 460.

Such embodiments allow for much greater memory and storage bandwidth. Processing units (e.g., IPU, CPU) of a node may access the memory and storage locally and at one or more other nodes in a distributed cloud of nodes (e.g., nodes a server rack).

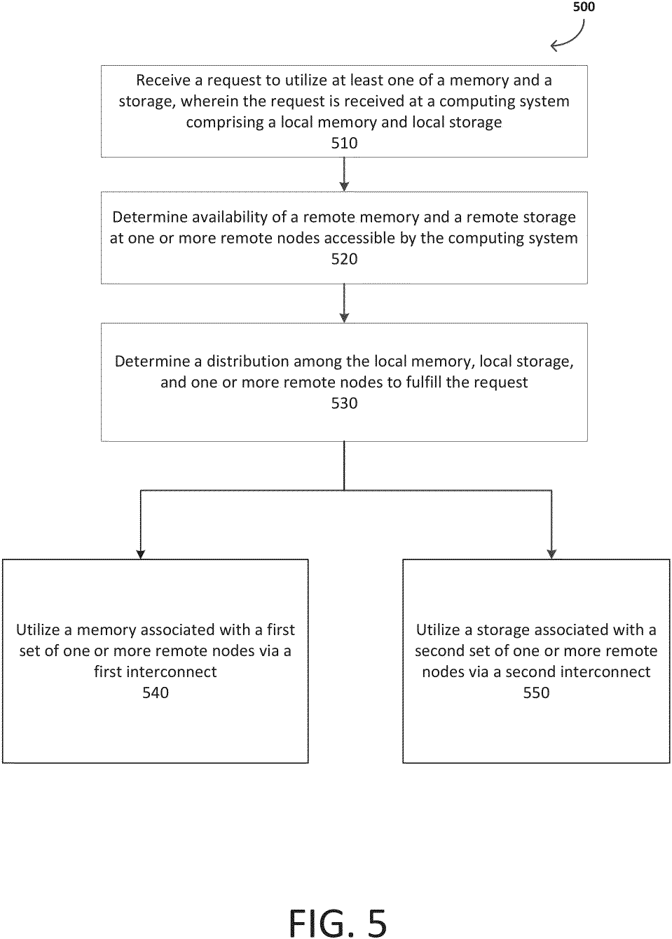

FIG. 5 provides flowchart of an exemplary method 500 for allocating memory and storage demands in accordance with embodiments. In embodiments, a system can receive a request to utilize at least one of a memory and a storage, wherein the request is received at a computing system comprising a local memory and a storage 510.

The system can determine availability of a remote memory and a remote storage at one or more remote nodes accessible by the computing system 520. Then, a distribution among the local memory, local storage, and one or more nodes is determined to fulfill the request 530. In examples, the distribution can be based on available memory and storage of local hardware and at external nodes. Based on the determination, at least one of the following operations can occur. They system can utilize a memory associated with a first set of one or more remote nodes via first interconnect 540. Alternatively, or in addition to the memory utilization, the system can utilize a storage associated with a second set of one or more remote nodes via a second interconnect 550.

### Configurable Load Store Unit

Disclosed herein is a configurable load store unit and related methods, systems, and devices. The configurable load store unit may be used in one or more computing nodes to implement a service, such as a web service, or next generation Web-Scale AI-enriched Big Data Service. The configurable load store unit can adapt to the diverse memory access pattern and memory organization used by big data applications. By exposing the control of memory scheduling and coalescing to the programmer, the configurable load store unit can achieve a better trade-off between memory access latency and bandwidth to meet the requirement from the application. In our experiments, the configurable load store unit can improve the latency of big data applications by 4x.

The disclosed techniques may address the bottleneck issue in conventional computer architecture, such as CPU, GPU and TPU, for a big data service. The disclosed techniques may be part of a technology platform that can be applied to other workloads, such as database management. The disclosed techniques can be adopted by other computer architectures, such as CPU, GPU and TPU.

Disclosed herein is a configurable load-store unit to reduce the data access latency by applying different scheduling/coalescing policy for different load/store instruction. Unlike a conventional LSU, a load/store instruction as disclosed herein may includes an operand indicating an identifier of one or more attributes for the load/store request. The instruction dispatcher may send a load/store request to a load/store unit(LSU) along with an attribute ID. The load store unit may look up the corresponding attribute stores in the config table according to the ID. The configurational table may have a plurality of configurations including the coalescing granularity, coalescing threshold, coalescing window, and QoS level. The coalescing granularity may be the size of a single memory request, which may be determined by the memory device and the organization (e.g., banking) . The coalescing threshold may determine a target efficiency (e.g., number of useful data bits / total number of bits in a request). The coalescing window may determine the maximum number of cycles for a memory request can be held for waiting more memory request to be coalesced. The QoS level may determine the priority of the scheduling.

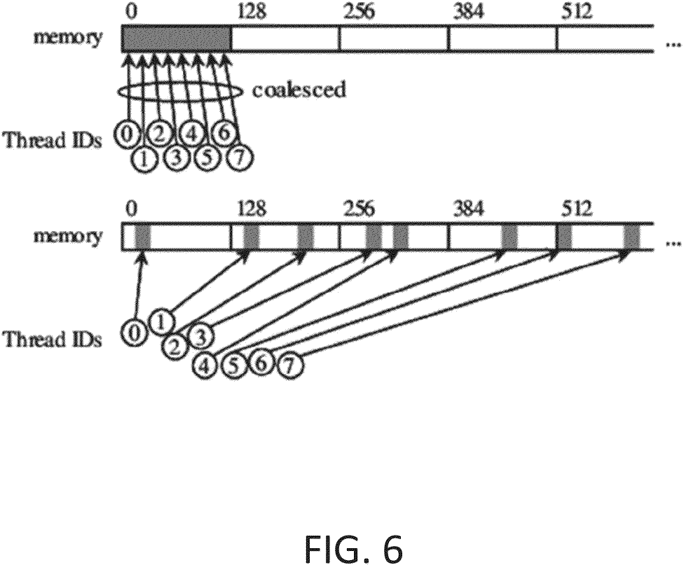

FIG. 6 shows an example of memory coalescing. Memory coalescing refers to the concept of combining multiple memory operations into a single transaction and/or single location . In the top panel of the figure, an example of coalescing is shown where several data bits are stored together in a memory block. In the bottom panel of the figure, an example is shown in which coalescing is not applied, which may involve storing data bits at any available location. Coalescing may lead to greater storage efficiency in some cases but may require a delays in time. One aspect of the present disclosure to dynamically change a coalescing process for different memory operations so that both efficiency and speed of performing the operation may be balanced.

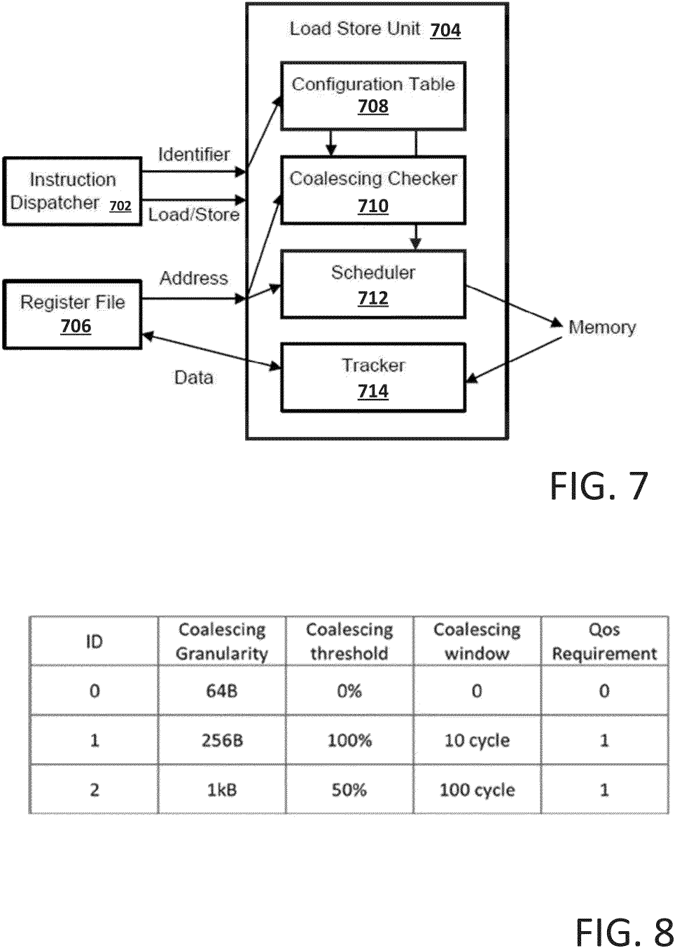

FIG. 7 shows an example device in accordance with the present disclosure. The device may comprise an instruction dispatcher 702. The instruction dispatcher may be configured to send a memory instruction. The memory instruction may be an instruction to one or more of load data or store data.

The device may comprise a load store unit 704 (e.g., or execution unit) . The load store unit 704 may be configured to communicate with a register file 706 to cause the register file 706 to load and/or store data.

The load store unit 704 may comprise a configurable load store unit 704. For example, the load store unit 704 may comprise a configuration table 708. An example configuration table 708 is shown in FIG. 8. The configuration table 708 may comprise one or more configuration attributes. The one or more configuration attributes may comprise information for controlling an amount of coalescing for storing data. The one or more configuration attributes may configure the load store unit 704 to group a plurality of instructions for loading or storing data as a single memory request to the register file, as multiple requests to the register file, and/or the like. The one or more configuration attributes may indicate latency and bandwidth requirements for memory register access.

The one or more configuration attributes may comprise one or more of a coalescing granularity, a coalescing threshold, a coalescing window, or a quality of service requirement. The one or more configuration attributes may indicate an amount of data to one or more of load or store during a single memory operation (e.g., or memory cycle, processor cycle). The one or more configuration attributes may indicate an efficiency for storing a useful data bits per total data bits. The one or more configuration attributes may indicate a maximum number of cycles of delay for performing the instruction.

The configuration table 708 may be edited, programmed, updated, rewritten, and/or the like. The configuration table 708 may be reconfigurable to one or more of add a new identifier and corresponding configuration attributes, remove an identifier and corresponding configuration attributes, or change a configuration attribute associated with an identifier.

Returning to FIG. 7, the load store unit 704 may be configured to receive the instruction from the instruction dispatcher 702. The load store unit 704 may be configured determine a configuration identifier associated with the instruction. The instruction may comprise an opcode. The instruction may comprise one or more operands. The opcode may comprise an operation to perform and the one or more operands may comprise a configuration identifier. The instruction dispatcher 702 may be configured to one or more of insert the configuration identifier in a field of the instruction or send the configuration identifier with the instruction. The load store unit 704 may be configured to determine the configuration identifier by accessing the configuration identifier in the field of the instruction or in data sent with the instruction. The load store unit 704 may be configured to determine, based on the configuration table and the configuration identifier, one or more configuration attributes. The configuration identifier may be used to look up corresponding configuration attributes in the configuration table 708.

The load store unit 704 may comprise a coalescing checker 710. The coalescing checker may be configured to determine and/or store information associated with analyzing coalescing of one or more instructions and/or memory operations. As instructions are received, one or more timers may be used to track a length of time since each instruction was received. The coalescing checker may determine a number of cycles since an instruction was received, an amount of data currently waiting to be stored in memory, priority of service information, and/or any other information that is used to evaluate whether the one or more configuration parameters are being satisfied.

The load store unit 704 may comprise a scheduler 712. The load store unit 704 may be configured to schedule, via the scheduler 712 and based on the one or more configuration attributes, timing of performing the instruction. The scheduler 712 may be configured to schedule timing of performing the instructions by one or more of scheduling a future time to perform the instruction, scheduling a period of delay, or delaying performing the instruction until a condition indicated in the one or more configuration attributes is satisfied. The scheduler 712 may be configured to schedule the timing based on information stored in the coalescing checker 710, satisfaction of one or more configuration parameters, an estimation of when the one or more configuration parameters may be satisfied, and/or the like.

The load store unit 704 may comprise a tracker 714. The tracker 714 may be configured to implement the schedule determined by the schedule 712. The tracker 714 send a request to the register file 706 to perform a memory operation based on the instruction. The register file 706 may be configured to receive and implement the instruction.

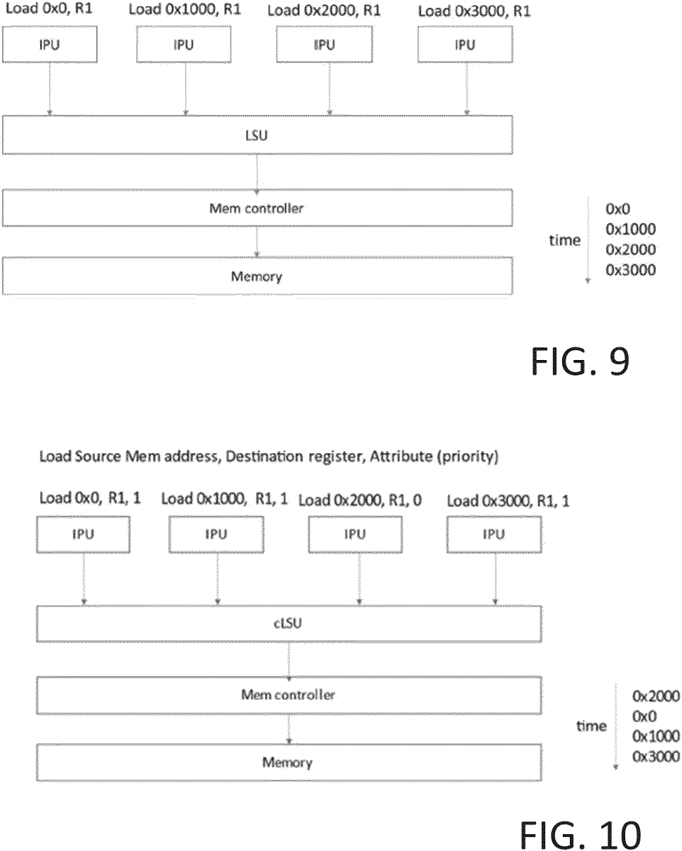

To support the configurable load store unit 702, a new instruction set architecture is disclosed herein. A shown in FIG. 9, a conventional computer instruction statement includes opcode and operands. The opcode indicates the operations performed by CPU which is associated some hardware function units. Operands are entities operated upon by the instruction, which could be immediate, register and memory.

As shown in FIG. 10, the present disclosure proposes adding a fourth type of operand, “attributes”, which defines how the instruction is executed by the hardware function units. Specifically, the hardware function unit may rearrange the execution order of instructions.

With the conventional ISA shown in FIG. 4, the memory controller cannot leverage the information from the software to guide the scheduling of memory access. As a result, the program cannot control the order of memory access. As shown in the FIG. 10, with the proposed ISA, the complier can use the priority attribute (e.g., “0” may be the highest) to direct the memory controller to serve the request from the third IPU first.

The disclosed techniques play a role in improving upon conventional systems. The following table. Table 1, shows a comparison of the system (e.g., labeled ENIAD) of the present disclosure compared in the context of natural language processing.

TABLE 1

| COMPARISON OF CPU-ONLY, GPU-ONLY VS. ENIAD-ACCELERATED SYSTEMS | | | | |
|---|---|---|---|---|
| NLP Index: MS GEN Encoder + HNSW (Graph Index) | | | | |
| | 1 CPU Node | 16 CPU Nodes | 1 ENIAD Node | Improvement |
| Index size | 100 M | 1B | 10B | ENIAD serves 10× larger index at 14× lower latency |
| E2E latency per batch 1 request, at 95% | 29 ms | 9.8 ms | 0.71 ms | |
| Image index: Deep1B + IVFPQ (Inverted File + Quantization Index) | | | | |
| | 1 CPU Node | 1 GPU Node | ¼ ENIAD Node | Improvement |
| Index size | 1B | 1B | 1B | ENIAD serves the same index size with 4× fewer nodes at 68 × lower latency |
| E2E latency per batch 1 request at 95% | 198 ms | 89 ms | 1.3 ms | |

In an aspect, the present configurable load store unit may be used in a variety of implementations, such as in a computer (e.g., chip, node) optimized to perform one or more of artificial intelligence, cognitive search, and/or the like. For example, cognitive search may improve search queries and extract relevant information from multiple, diverse data sets. The configurable load store unit may allow for much more efficient processing of a variety of data sets for the purpose of improving a user search. Cognitive search may include indexing, natural language process, machine learning, and natural human interaction (NHI). Cognitive search may be more advanced than keyword search, semantic search, contextual search, and/or the like. The configurable load store unit may be included in one or more processing units (e.g., IPUs) of one or more nodes of a service provider the provides the search service (e.g., via a network). FIG. 8 shows an example process for implementing an artificial intelligence AI based search service (e.g., a cognitive search service). The disclosed system (e.g., one or more nodes having a configurable load store unit) may be configured to implement one or more of the processes and/or store any of the data disclosed in FIG. 8. The system may ingest data. The system may perform index management. The system may perform query processing.

With the presently disclosed systems, conventional AI search services may be improved. In Table 2, a comparison is shown of a conventional cognitive search service to the requirements of a typical search engine. The disclosed techniques may be used to improve conventional cognitive search to be capable of more typical search requirements.

TABLE 2

| | | |
|---|---|---|
| | Microsoft Azure Cognitive Search Capability | GOOGLE Search Requirement |
| Dataset size | 7.5 million | 40 trillion |
| Query per second | < 300 | 70.000 |
| 99% Tail Latency | > 400 ms | < 7 ms |

### Computational Register File

Disclosed herein is a computational register file and related methods, systems, and devices. The computational register file may be used in one or more computing nodes to implement a next generation Web-Scale AI-enriched Big Data Service. The one or more computing nodes may be configured to serve 10x dataset scale (e.g., > 10 trillion), 14x lower latency, and 4x fewer cost as compared to conventional computing devices.

The disclosed computational register file is one of the key technologies for increasing the performance of a computing node. The disclosed techniques may address at least in part, the bottleneck issue in conventional computer architecture, such as CPU, GPU and TPU, for a big data service. The disclosed techniques may be part of a technology platform that can be applied to other workloads, such as database management. The disclosed techniques can be adopted by other computer architectures, such as CPU, GPU and TPU.

Computing is not only increasingly requiring more powerful processors but also requiring extremely efficient memory subsystem. For example, big data such as, but not limited to, search engine, requires a processor capable of performing an extremely high throughput of data processing such as, but not limited to, sorting. Executing big data application such as, but not limited to, search engine, on a general-purpose processor can be extremely expensive.

A computational register file (CRF) that may be integrated into a processor is disclosed herein. A conventional Register file (RF) in modem processors is an array of registers that can be read from/written into by function units (such as ALUs). Each register may contain one (scalar register) or more storage elements (vector register). In addition to the storage elements, a computational register file may have computational logic configured to perform operations on one or more words that are in the register file, to be written into the register file. The computational register file may store the results of the operations into the register file. Finally, functional units can read the result from the register file. Also, the CRF can perform operations on one or more words that are in the register file and use the result as the response to a read operation.

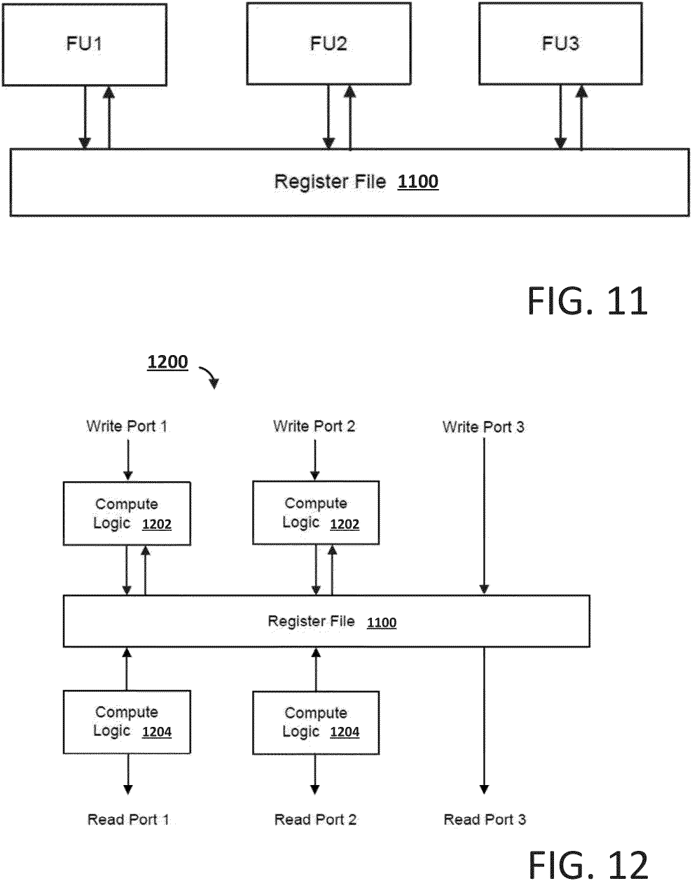

FIG. 11 shows an example register file. The register file may be configured to communicate with one or more functional units FU1, FU2. and FU2. The one or more functional units may communicate instructions and/or data to the register file. The example register file may be configured to provide (e.g., to the one or more functional units) two functions: 1) updating the register according to an instruction (address, content) pair, also known as write operation; and 2) retrieving the content according to an instruction (address, content) pair, also known as read operation. It is worth noting that, a conventional register file may not perform any operations on the content itself for either read or write. In other words, the instruction (address, content) pair may not be changed by read/write functions.

FIG. 12 shows an example computational register file 1200 as disclosed herein. The computation register file 1200 improves upon the register file 1100 shown in FIG. 11. The computational register file 1200 may perform operations on one or more words that are in the register file, to be written into the register file 1100. The computational register file 1200 may then store the results back into the register file 1100. Also, the computational register file 1200 may perform operations on one or more words that are in the register file 1100 and use the result as the response to the read operation. In summary, the computational register file 1200 disclosed herein may perform in situ operations on the content during read/write operations instead of only performing read/write operations. The (address, content) pair can be changed by the computational register file 1200 operations.

The computational register file 1200 may be configured to perform multiple data-dependent operations in a single read-write cycle. A processor may need to perform a sequence of data-dependent operations (e.g., insert data elements to a sorted array, also known as ranking) using multiple instructions. To implement the sequence of data-dependent functions, a functional unit may need to access the register file 1100 of FIG. 11 several times. The functional unit may have to wait for the data to be read from/written into the register file of FIG. 1 to be complete before performing the next operation in the sequence of operations. This approach may require multiple processor cycles and thus significantly reduce the computing efficiency. The computational register file shown in FIG. 12 can enable the same sequence of operations to be performed using one instruction which can complete in a single processor cycle.

The computational register file 1200 may comprise a register file 1100 (e.g., such as a conventional register file, or register file modified to implement the present disclosure). The computational register file 1200 may comprise one or more computational logic units 1202 configured for write operations. The computational register file 1200 may comprise one or more computational logic units 1204 configured for read operations. The computational register file 1200 may comprise read/write ports to/from computational logic (CRF read/write), such as write port 1, write port 2, read port 1, and read port 2. The computational register file 1200 may comprise read/write ports to/from register file 11000 directly (RF read/write), such as write port 3 and read port 3. It is worth noting that the width of read/write ports to/from computational logic may not be equal to the input/output width of the conventional register file. However, the width of the read/write ports to/from conventional register file may be equal to the input/output width of the conventional register file.

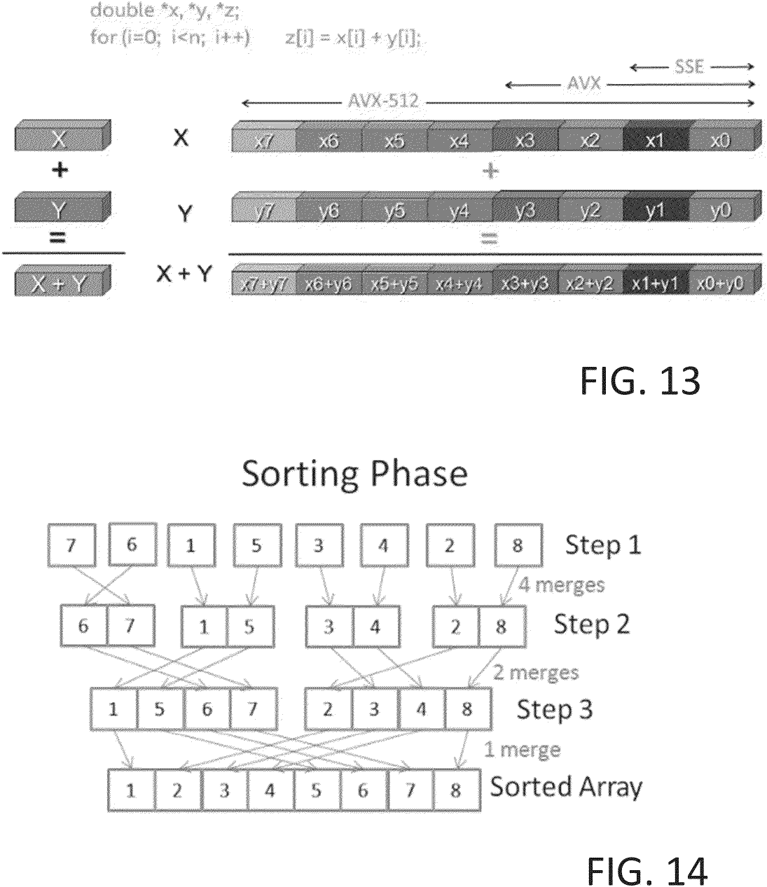

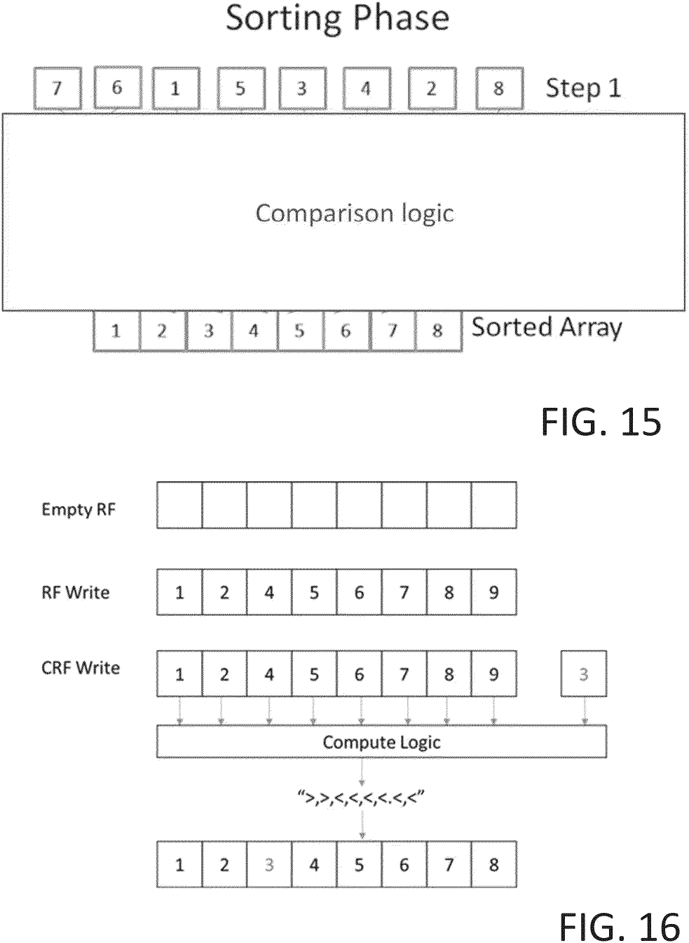

As an illustration, the computational register file may be configured to implement an 8-element priority queue. FIGS. 13-14 illustrate implementation of the priority queue using the register 1100 of FIG. 11. FIGS. 15-16 illustrate implementation of priority queue using the computation register file 1200 of FIG. 12.

FIG. 13 shows example arithmetic operation for the register file 1100 of FIG. 11. There may be no fine-grained data movement, no data dependency, and/or the output size may equal the input size. FIG. 14 shows an example sorting operation of the register file 1100 of FIG. 11. The register file 100 of FIG. 11 may have to perform each step by first comparison of data and then moving data according to the result. This process may require many data movements and many instructions. For example, in each step, shown in FIG. 14, the register file 1100 of FIG. 11 may need to perform one or more read write operations. In contrast, as shown in FIG. 15, the comparison logic may perform each of the steps of FIG. 14 and then only perform a single write operation store the resulting sorted array.

As shown in FIGS. 15-16, at the beginning, the queue may be initialized by writing a vector “1,2,4,5,6,7,8,9” through write port 3 into the register file 1100. When a new data element arrives, e.g. “3”, it may be written into the computational register file 1200 via write port 1. The computational logic (e.g., computational logic 1202 of port 1) of the computational register file 1200 may read out the vector from the register file 1100 and compare each element with the new data (e.g., “3”). The result would be “>,>,<,<,<,<,<,<”. Based on the result, the computational logic will write the vector “1,2,3,4,5,6,7,8” back into the conventional register file. This insertion step could be repeated by arbitrary times. In the end, the content of the priority queue could be read out through the read port 3.

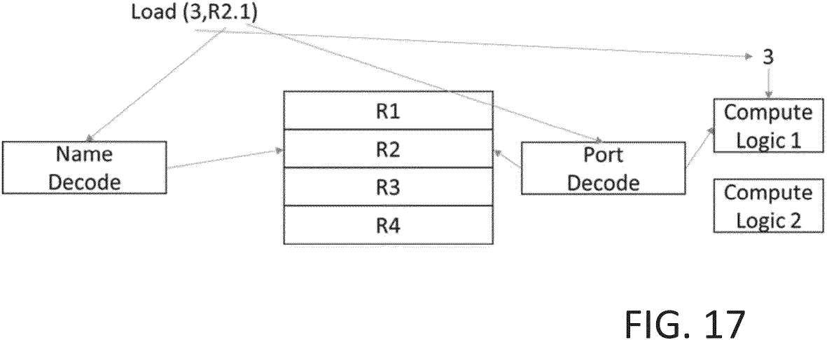

FIG. 17 shows a diagram of an example instruction for the computational register file. To support the computational register file in an instruction set architecture, the operand name may be expanded from RX to RX.Y, where X is the name of the register and Y is a port ID of the register. The name of the register X may select which register in the register file to be used. The port ID Y may select which computational logic to be used.

The instruction decoding (e.g., register name decoding and port name decoding) may be responsible for decoding the operand in the instruction and generating the appropriate control signal to select corresponding register file and control logics. As shown in the FIG. 17, only one load instruction is needed for the computational register file to insert the element “3” into the priority queue. The example load instruction includes a first value indicating the data (e.g., the value “3”). Th example load instruction has a second value indicating an instruction. The instruction may comprise a first value indicating a register name (e.g., R2). The instruction may comprise a second value indicating a port identifier. The first instruction and the second instruction may be separated by a character, such as a period.

In our evaluation (real hardware prototype), the disclosed computational register file can provide more than 38x throughput of the ranking operation which is a key step and the performance bottleneck of the state-of-the-art search algorithm over conventional processor.

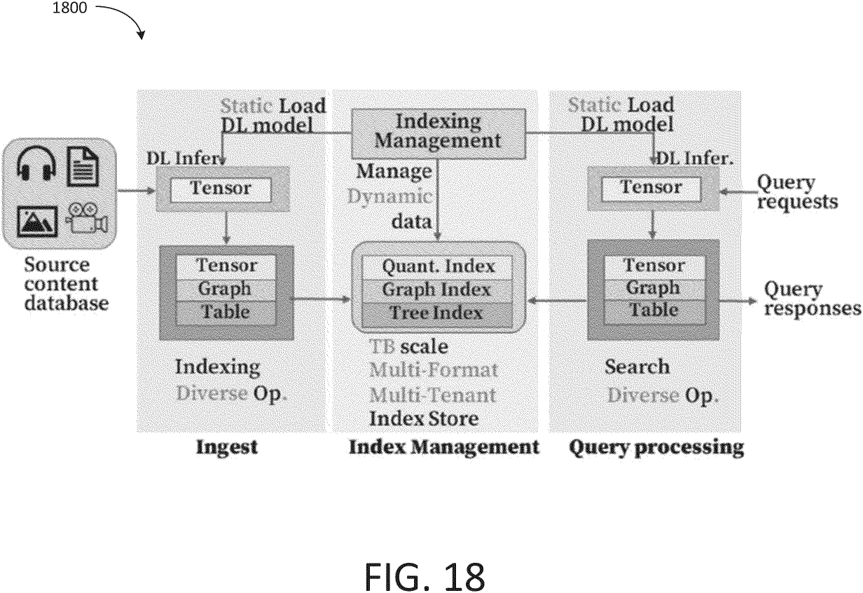

FIG. 18 shows an example process 1800 for implementing an artificial intelligence AI based search service (e.g.. a cognitive search service). The disclosed system (e.g., one or more nodes having a computational register file) may be configured to implement one or more of the processes and/or store any of the data disclosed in FIG. 18. The system may ingest data. The system may perform index management. The system may perform query processing.

With the presently disclosed systems, conventional AI search services may be improved. In Table 2 (above), a comparison is shown of a conventional cognitive search service to the requirements of a typical search engine. The disclosed techniques may be used to improve conventional cognitive search to be capable of more typical search requirements.

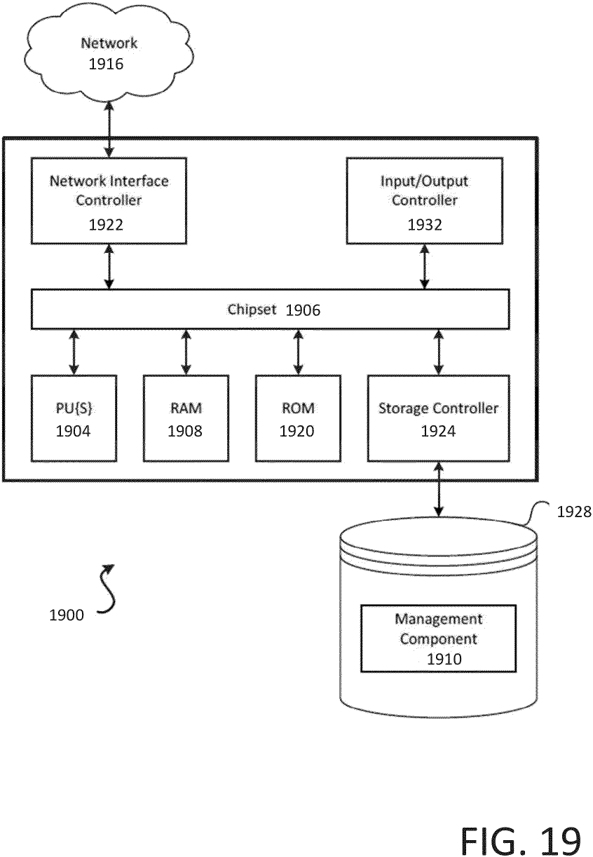

FIG. 19 depicts a computing device that may be used in various aspects, such as servers, computing, and/or devices comprising the configurable load store unit 1204 of FIG. 12 and/or the system of FIGS. 16-17. The computer architecture shown in FIG. 19 shows a server computer, workstation, desktop computer, laptop, tablet, network appliance, PDA, e-reader, digital cellular phone, or other computing node, and may be utilized to execute any aspects of the computers described herein, such as to implement the methods herein.

The computing device 1900 may include a baseboard, or “motherboard,” which is a printed circuit board to which a multitude of components or devices may be connected by way of a system bus or other electrical communication paths. The computing device 1900 may comprise one or more processing units, such as a central processing unit, intelligence processing unit (IPU), graphics processing unit (GPU), and/or any other processor described herein. At least one of the one or more processing units 904 may comprise the configurable load store unit of FIG. 12, and/or the processing unit of FIGS. 16-17. The one or more processing units 1904 may operate in conjunction with a chipset 1906. The PU(s) 1904 may be standard programmable processors that perform arithmetic and logical operations necessary for the operation of the computing device 1900.

The one or more processing units 1904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The PU(s) 1904 may be augmented with or replaced by other processing units, such as GPU(s), IPU(s), and/or the like. The GPU(s) and/or IPU(s) may comprise processing units specialized for but not necessarily limited to highly parallel computations, such as graphics and other visualization-related processing. The other processing units may comprise the configurable load store unit of FIG. 12, and/or the processing unit of FIGS. 16-17.

A chipset 1906 may provide an interface between the CPU(s) 1904 and the remainder of the components and devices on the baseboard. The chipset 1906 may provide an interface to a random access memory (RAM) 1908 used as the main memory in the computing device 1900. The chipset 1906 may further provide an interface to a computer-readable storage medium, such as a read-only memory (ROM) 1920 or non-volatile RAM (NVRAM) (not shown), for storing basic routines that may help to start up the computing device 1900 and to transfer information between the various components and devices. ROM 1920 or NVRAM may also store other software components necessary for the operation of the computing device 1900 in accordance with the aspects described herein.

The computing device 1900 may operate in a networked environment using logical connections to remote computing nodes and computer systems through local area network (LAN) 1916. The chipset 1906 may include functionality for providing network connectivity through a network interface controller (NIC) 1922, such as a gigabit Ethernet adapter. A NIC 1922 may be capable of connecting the computing device 1900 to other computing nodes over a network 1916. It should be appreciated that multiple NICs 1922 may be present in the computing device 1900, connecting the computing device to other types of networks and remote computer systems.

The computing device 1900 may be connected to a mass storage device 1928 that provides non-volatile storage for the computer. The mass storage device 1928 may store system programs, application programs, other program modules, and data, which have been described in greater detail herein. The mass storage device 1928 may be connected to the computing device 1900 through a storage controller 1924 connected to the chipset 1906. The mass storage device 1928 may consist of one or more physical storage units. A storage controller 1924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1900 may store data on a mass storage device 1928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1928 is characterized as primary or secondary storage and the like.

For example, the computing device 1900 may store information to the mass storage device 1928 by issuing instructions through a storage controller 1924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1900 may further read information from the mass storage device 1928 by detecting the physical states or characteristics of one or more particular locations within the physical storage units.

In addition to the mass storage device 1928 described above, the computing device 1900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1928 depicted in FIG. 19, may store an operating system utilized to control the operation of the computing device 1900. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1928 may store other system or application programs and data utilized by the computing device 1900.

The mass storage device 1928 or other computer-readable storage media may also be encoded with computer-executable instructions, which, when loaded into the computing device 1900, transforms the computing device from a general-purpose computing system into a special-purpose computer capable of implementing the aspects described herein. These computer-executable instructions transform the computing device 1900 by specifying how the PU(s) 1904 transition between states, as described above. The computing device 1900 may have access to computer-readable storage media storing computer-executable instructions, which, when executed by the computing device 1900, may perform the methods described in herein.

A computing device, such as the computing device 1900 depicted in FIG. 19, may also include an input/output controller 1932 for receiving and processing input from a number of input devices, such as a keyboard, a mouse, a touchpad, a touch screen, an electronic stylus, or other type of input device. Similarly, an input/output controller 1932 may provide output to a display, such as a computer monitor, a flat-panel display, a digital projector, a printer, a plotter, or other type of output device. It will be appreciated that the computing device 1900 may not include all of the components shown in FIG. 19, may include other components that are not explicitly shown in FIG. 19, or may utilize an architecture completely different than that shown in FIG. 19.

As described herein, a computing device may be a physical computing device, such as the computing device 1900 of FIG. 19. A computing node may also include a virtual machine host process and one or more virtual machine instances. Computer-executable instructions may be executed by the physical hardware of a computing device indirectly through interpretation and/or execution of instructions stored and executed in the context of a virtual machine. The computing device 1900 may be configured to communicate via the network 1916 with other devices. For example, the computing device 1910 may process requests for a service, such as a search service (e.g., cognitive search service, artificial intelligence service, indexing service, natural language processing service, machine learning service, or a combination thereof).

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

### Aspects

The disclosure includes any of the following Aspects, which are illustrative only and do not serve to limit the scope of the present disclosure or the appended claims.

Aspect 1. A method, comprising: receiving a request to utilize at least one of a memory and a storage, wherein the request is received at a computing system comprising a local memory and local storage: determining availability of a remote memory and a remote storage at one or more remote nodes accessible by the computing system; determining a distribution among the local memory, local storage, and one or more remote nodes to fulfill the request; and based on the determination, utilizing at least one of: a memory associated with a first set of one or more remote nodes via a first interconnect; and a storage associated with a second set of one or more remote nodes via a second interconnect.

Aspect 2. The method of Aspect 1, further comprising utilizing at least one of the local memory and the local storage to fulfill the request.

Aspect 3. The method of any of Aspects 1 and 2, further comprising reducing a latency period for the request using the first and/or second interconnect.

Aspect 4. The method of any of Aspects 1-3. wherein the request comprises access to at least one of a local memory and a local storage via a primary processing unit.

Aspect 5. The method of Aspect 4, further comprising: disaggregating the local memory from the primary processing unit of the computing system using the first interconnect; and disaggregating the local storage from the primary processing unit using the second interconnect.

Aspect 6. The method of Aspect 5, wherein the local memory and the local storage are disaggregated into a Field Programmable Gate Array (FPGA)-independent storage and memory.

Aspect 7. The method of Aspect 4, further comprising reducing data access overhead by bypassing the primary processing unit.

Aspect 8. A system, comprising: at least one processing unit; a local memory; a local storage; a first interconnect configured to access a remote memory at a first set of one or more remote nodes; a second interconnect configured to access a remote storage at a second set of one or more remote nodes; and instructions that when executed on the at least one processing unit, cause the system to at least: receive a request to utilize at least one of a memory and a storage; determine availability of at least one of the remote memory and the remote storage at the first and second set of remote nodes: determine a distribution among the local memory, local storage, and one or more remote nodes to fulfill the request; and utilize at least one of: the remote memory associated with a first set of one or more remote nodes; and the remote storage associated with a second set of one or more remote nodes.

Aspect 9. The system of Aspect 8, wherein the at least one processing unit is one or more of an Intelligence Processing Unit (IPU) and Central Processing Unit (CPU).

Aspect 10. The system of any of Aspects 8-9, wherein the first interconnect is a storage interconnect and the second interconnect is a memory interconnect.

Aspect 11. The system of any of Aspects 8-10, wherein the first set of one or more remote nodes utilizes an RDMA network.

Aspect 12. The system of any of Aspects 8-11. wherein the second set of one or more remote nodes utilizes a Peripheral Component Interconnect Express (PCIe) network.

Aspect 13. The system of any of Aspects 8-12, wherein at least one of a soft PCIe switch and a hard PCIe switch enables access to the second set of the one or more remote nodes.

Aspect 14. The system of any of Aspects 8-13, further comprising instructions to cause the system to utilize at least one of the local memory and the local storage to fulfill the request.

Aspect 15. The system of any of Aspects 8-14, wherein the request comprises access to at least one of a local memory and a local storage via a primary processing unit.

Aspect 16. The system of any of Aspects 8-15, wherein the system is a search engine.

Aspect 17. The system of any of Aspects 8-16, further comprising instructions that cause the system to: disaggregate the local memory from the at least one processing unit using the first interconnect; and disaggregate the local storage from the at least one processing unit using the second interconnect.

Aspect 18. The system of Aspect 17. wherein the local memory and the local storage are disaggregated into a Field Programmable Gate Array (FPGA)-independent storage and memory

Aspect 19. A method, comprising operating a system according to any one of Aspects 8 to 18.

Aspect 20. The method of Aspect 19, wherein the operating comprises executing a search.

Aspect 21. A method comprising, consisting of, or consisting essentially of: receiving, by an execution unit of a processor, an instruction to one or more of load data or store data; determining a configuration identifier associated with the instruction; determining, based on a configuration table and the configuration identifier, one or more configuration attributes; and scheduling, based on the one or more configuration attributes, timing of performing the instruction.

Aspect 22. The method of Aspect 21, wherein the instruction comprises an opcode and one or more operands, wherein the opcode comprises an operation to perform and the one or more operands comprise the configuration identifier.

Aspect 23. The method of any one of Aspects 21-22, wherein determining the configuration identifier comprises accessing the configuration identifier in an operand field that is one or more of included in the instruction or provided with the instruction.

Aspect 24. The method of any one of Aspects 21-23, wherein the one or more configuration attributes comprise one or more of a coalescing granularity, a coalescing threshold, a coalescing window, or a quality of service requirement.

Aspect 25. The method of any one of Aspects 21-24, wherein the one or more configuration attributes indicate an amount of data to one or more of load or store during a single memory operation.

Aspect 26. The method of any one of Aspects 21-25, wherein the one or more configuration attributes indicate an efficiency for storing a useful data bits per total data bits.

Aspect 27. The method of any one of Aspects 21-26, wherein the one or more configuration attributes indicate a maximum number of cycles of delay for performing the instruction.

Aspect 28. The method of any one of Aspects 21-27, wherein scheduling timing of performing the instructions comprises one or more of scheduling a future time to perform the instruction, scheduling a period of delay, or delaying performing the instruction until a condition indicated in the one or more configuration attributes is satisfied.

Aspect 29. The method of any one of Aspects 21-28, wherein the execution unit comprises a load/store unit configured to load data and store data in one or more processor registers.

Aspect 30. The method of any one of Aspects 21-29, wherein the execution unit comprises the configuration table.

Aspect 31. The method of any one of Aspects 21-30, wherein the one or more configuration attributes configure the execution unit to group a plurality of instructions for loading or storing data as a single memory request to a register.

Aspect 32. The method of any one of Aspects 21-31. wherein the one or more configuration attributes indicate latency and bandwidth requirements for memory register access.

Aspect 33. The method of any one of Aspects 21-32, further comprising updating the configuration table to one or more of add a new identifier and corresponding configuration attributes, remove an identifier and corresponding configuration attributes, or change a configuration attribute associated with an identifier.

Aspect 34. A device comprising, consisting of, or consisting essentially of: an instruction dispatcher configured to send an instruction to one or more of load data or store data; an execution unit comprising a configuration table and a scheduler, wherein the execution unit is configured to: receive the instruction: determine a configuration identifier associated with the instruction: and determine, based on the configuration table and the configuration identifier, one or more configuration attributes; and schedule, via the scheduler and based on the one or more configuration attributes, timing of performing the instruction; and a register file configured to receive, based on at least the instruction, a request to perform a memory operation.

Aspect 35. The device of Aspect 34, wherein the instruction comprises an opcode and one or more operands, wherein the opcode comprises an operation to perform and the one or more operands comprise the configuration identifier.

Aspect 36. The device of any one of Aspects 34-35, wherein the instruction dispatcher is configured to one or more of insert the configuration identifier in a field of the instruction or send the configuration identifier with the instruction, and wherein the execution unit is configured determining the configuration identifier by accessing the configuration identifier in the field of the instruction or in data sent with the instruction.

Aspect 37. The device of any one of Aspects 14-16, wherein the one or more configuration attributes comprise one or more of a coalescing granularity, a coalescing threshold, a coalescing window, or a quality of service requirement.

Aspect 38. The device of any one of Aspects 34-37, wherein the one or more configuration attributes indicate an amount of data to one or more of load or store during a single memory operation.

Aspect 39. The device of any one of Aspects 34-38, wherein the one or more configuration attributes indicate an efficiency for storing a useful data bits per total data bits.

Aspect 40. The device of any one of Aspects 34-39, wherein the one or more configuration attributes indicate a maximum number of cycles of delay for performing the instruction.

Aspect 41. The device of any one of Aspects 34-40. wherein the scheduler is configured to schedule timing of performing the instructions by one or more of scheduling a future time to perform the instruction, scheduling a period of delay, or delaying performing the instruction until a condition indicated in the one or more configuration attributes is satisfied.

Aspect 42. The device of any one of Aspects 34-41, wherein the execution unit comprises a load/store unit configured to load data and store data in the register file.

Aspect 43. The device of any one of Aspects 34-42. wherein the one or more configuration attributes configure the execution unit to group a plurality of instructions for loading or storing data as a single memory request to the register file.

Aspect 44. The device of any one of Aspects 34-43, wherein the one or more configuration attributes indicate latency and bandwidth requirements for memory register access.

Aspect 45. The device of any one of Aspects 34-44, wherein configuration table is reconfigurable to one or more of add a new identifier and corresponding configuration attributes, remove an identifier and corresponding configuration attributes, or change a configuration attribute associated with an identifier.

Aspect 46. A system comprising, consisting of, or consisting essentially of: a processor; and an instruction dispatcher, an execution unit, and a register file according to any one of Aspects 34-45.

Aspect 47. A system comprising, consisting of, or consisting essentially of: a plurality of processing units configured to perform any one of the methods of Aspects 21-33.

Aspect 48. The system of claim 47, wherein the plurality of processing units are distributed among one or more of: a plurality of separate computing devices, a plurality of geographically distributed devices, a plurality of server blades, a plurality of server racks, a plurality of server locations.

Aspect 49. The system of any one of Aspects 47-48, wherein the system is configured to distribute data processing loads among the plurality of processing unit.

Aspect 50. The system of Aspect 49, wherein the data processing loads comprise loads for one or more of a cognitive search service, an artificial intelligence service, or a network based data analysis service.

Aspect 51. A method comprising, consisting of, or consisting essentially of: generating, by a processing unit, an instruction for a register file associated with the processing unit; sending the instruction to a first port of the register file; performing, based on the instruction and logic associated with the first port, a plurality of operations; and causing, based on one or more results of the plurality of operations, an update to the register file.

Aspect 52. The method of Aspect 51, wherein the plurality of operations comprises a first operation and a second operation dependent on a result of the first operation.

Aspect 53. The method of Aspect 52. wherein the first operation is based on logic coupled to the first port and data from the register file.

Aspect 54. The method of any one of Aspects 51-53, wherein the plurality of operations are performed in a single memory read/write cycle.

Aspect 55. The method of any one of Aspects 51-54, wherein the logic associated with the first port comprises reconfigured logic configured to perform the plurality of operations.

Aspect 56. The method of any one of Aspects 51-55, wherein the register file comprises the first port and a second port, wherein the first port provides data to a first operation and the second port is provides data to a second operation different than the first operation.

Aspect 57. The method of any one of Aspects 51-56, wherein the register file comprises a plurality of addressable memory locations.

Aspect 58. The method of any one of Aspects 51-57, wherein the processing unit comprises one or more of a central processing unit, a tensor processing unit, or a graphics processing unit.

Aspect 59. The method of any one of Aspects 51-58, wherein the one or more results comprise a multi-dimensional result matrix.

Aspect 60. The method of any one of Aspects 51-59, wherein the plurality of operations comprises one or more of updating ordering of a queue stored in the register file, sorting an array of values stored in the register file, an operation dependent on another operation in the plurality of operations, or an operation having an input size different than an output size.

Aspect 61. The method of any one of Aspects 51-60, wherein the plurality of operations implements one or more of an artificial intelligence based search or a cognitive search.

Aspect 62. The method of any one of Aspects 51-61, wherein the register file is a component of the processing unit.

Aspect 63. The method of any one of Aspects 51-62, wherein sending the instructions indicate a data value, a memory address of the register file, and the first input.

Aspect 64. The method of any one of Aspects 51-63, further comprising determining, based on a context associated with the instruction, which input of a plurality of inputs of the register file to send the instructions, wherein the first input is select based on the first input matching the context.

Aspect 65. The method of any one of Aspects 51-64, wherein the plurality of operations are performed in the register file.

Aspect 66. The method of any one of Aspects 51-65, wherein the logic associated with the first input comprises logic comprised in the register file.

Aspect 67. The method of any one of Aspects 51-66, further comprising sending an additional instruction to a third input, wherein the third input causes a memory value to be one or more of accessed or updated without performing logic operations.

Aspect 68. The method of any one of Aspects 51-67, wherein causing the update to the register file comprises causing, based on the instruction, a plurality of updates to a plurality of data values stored in the register file.

Aspect 69. A device comprising, consisting of, or consisting essentially of: a processing unit: and a register file in communication with the processing unit and configured to perform the methods of any one of Aspects 51-68.

Aspect 70. A non-transitory computer-readable medium storing instructions that, when executed by one or more processors, cause a device to perform the methods of any one of Aspects 51-68.

Aspect 71. A system comprising, consisting of, or consisting essentially of: a first device configured to send data via a network; and a second device configured to receive the data via the network and perform, based on the data, the methods of any one of Aspects 51-68.

Aspect 72. A computational register file, comprising, consisting of, or consisting essentially of: a plurality of input ports comprising a first input port and a second input port; a plurality of logic units comprising a first logic unit and a second logic unit, wherein the first logic unit is communicatively coupled to the first input port and configured to perform a first plurality of operations, and wherein the second logic unit is communicatively coupled to the second input port: and a register file communicatively coupled to the plurality of logic units. At least a portion of the plurality of input ports may be configured to receive instructions for the register file and supply (e.g., based on a parameter in the instruction and/or based on a coupling of the port to the logic unit) the instructions to a corresponding logic unit of the plurality of logic units, which performs a sequence of corresponding operations programmed into the logic unit to data (e.g., from the register file, or supplied in the instruction) and applies the result of the sequence of operations to the register file.

Aspect 73. The computational register file of Aspect 72, wherein the plurality of logic units are programmable.

Aspect 74. The computational register file of any one of Aspects 72-73, wherein the first logic unit is configured to receive a memory command, access data from the register file based on the memory command, perform the plurality of operations on the data, and cause the register file to store a result of the plurality of operations.

Aspect 75 The computational register file of any one of Aspects 72-74, wherein the plurality of input ports comprises a third input port communicatively coupled to the register file without being coupled to any of the plurality of logic units.

Aspect 76. The computational register file of any one of Aspects 72-75, wherein the computational register file is configured to perform any of the actions and/or include any of the features of Aspects 51-68.

What is claimed:

1. A method, comprising:
receiving a request to utilize at least one of a memory and a storage, wherein the request is received at a computing system comprising a local memory and local storage;
determining availability of a remote memory and a remote storage at one or more remote nodes accessible by the computing system;
determining a distribution among the local memory, local storage, and one or more remote nodes to fulfill the request; and
based on the determination, utilizing at least one of:
a memory associated with a first set of one or more remote nodes via a first interconnect; and
a storage associated with a second set of one or more remote nodes via a second interconnect.

2. The method of claim 1, further comprising utilizing at least one of the local memory and the local storage to fulfill the request.

3. The method of claim 1, further comprising reducing a latency period for the request using the first and/or second interconnect.

4. The method of claim 1, wherein the request comprises access to at least one of a local memory and a local storage via a primary processing unit.

5. The method of claim 4, further comprising:
disaggregating the local memory from the primary processing unit of the computing system using the first interconnect; and
disaggregating the local storage from the primary processing unit using the second interconnect.

6. The method of claim 5, wherein the local memory and the local storage are disaggregated into a Field Programmable Gate Array (FPGA)-independent storage and memory.

7. The method of claim 4, further comprising reducing data access overhead by bypassing the primary processing unit.

8. A system, comprising:
at least one processing unit;
a local memory;
a local storage;
a first interconnect configured to access a remote memory at a first set of one or more remote nodes;
a second interconnect configured to access a remote storage at a second set of one or more remote nodes; and
instructions that when executed on the at least one processing unit, cause the system to at least:
receive a request to utilize at least one of a memory and a storage;
determine availability of at least one of the remote memory and the remote storage at the first and second set of remote nodes;
determine a distribution among the local memory, local storage, and one or more remote nodes to fulfill the request; and
utilize at least one of:
the remote memory associated with a first set of one or more remote nodes; and
the remote storage associated with a second set of one or more remote nodes.

9. The system of claim 8, wherein the at least one processing unit is one or more of an Intelligence Processing Unit (IPU) and Central Processing Unit (CPU).

10. The system of claim 8, wherein the first interconnect is a storage interconnect and the second interconnect is a memory interconnect.

11. The system of claim 8,. wherein the first set of one or more remote nodes utilizes an RDMA network.

12. The system of claim 8,. wherein the second set of one or more remote nodes utilizes a Peripheral Component Interconnect Express (PCIe) network.

13. The system of claim 8, wherein at least one of a soft PCIe switch and a hard PCIe switch enables access to the second set of the one or more remote nodes.

14. The system of claim 8, further comprising instructions to cause the system to utilize at least one of the local memory and the local storage to fulfill the request.

15. The system of claim 8, wherein the request comprises access to at least one of a local memory and a local storage via a primary processing unit.

16. The system of claim 8, wherein the system is a search engine.

17. The system of claim 8, further comprising instructions that cause the system to:
disaggregate the local memory from the at least one processing unit using the first interconnect; and
disaggregate the local storage from the at least one processing unit using the second interconnect.

18. The system of claim 17, wherein the local memory and the local storage are disaggregated into a Field Programmable Gate Array (FPGA)-independent storage and memory.

19. A method, comprising operating a system according to claim 8.

20. The method of claim 19, wherein the operating comprises executing a search.

21. A method comprising:
receiving, by an execution unit of a processor, an instruction to one or more of load data or store data;
determining a configuration identifier associated with the instruction;
determining, based on a configuration table and the configuration identifier, one or more configuration attributes; and
scheduling, based on the one or more configuration attributes, timing of performing the instruction.

22. The method of claim 21, wherein the instruction comprises an opcode and one or more operands, wherein the opcode comprises an operation to perform and the one or more operands comprise the configuration identifier.

23. The method of claim 21, wherein determining the configuration identifier comprises accessing the configuration identifier in an operand field that is one or more of included in the instruction or provided with the instruction.

24. The method of claim 21, wherein the one or more configuration attributes comprise one or more of a coalescing granularity, a coalescing threshold, a coalescing window, or a quality of service requirement.

25. The method of claim 21, wherein the one or more configuration attributes indicate an amount of data to one or more of load or store during a single memory operation.

26. The method of claim 21, wherein the one or more configuration attributes indicate an efficiency for storing a useful data bits per total data bits.

27. The method of claim 21, wherein the one or more configuration attributes indicate a maximum number of cycles of delay for performing the instruction.

28. The method of claim 21, wherein scheduling timing of performing the instructions comprises one or more of scheduling a future time to perform the instruction, scheduling a period of delay, or delaying performing the instruction until a condition indicated in the one or more configuration attributes is satisfied.

29. The method of claim 21, wherein the execution unit comprises a load/store unit configured to load data and store data in one or more processor registers.

30. The method of claim 21, wherein the execution unit comprises the configuration table.

31. The method of claim 21, wherein the one or more configuration attributes configure the execution unit to group a plurality of instructions for loading or storing data as a single memory request to a register.

32. The method of claim 21, wherein the one or more configuration attributes indicate latency and bandwidth requirements for memory register access.

33. The method of claim 21, further comprising updating the configuration table to one or more of add a new identifier and corresponding configuration attributes, remove an identifier and corresponding configuration attributes, or change a configuration attribute associated with an identifier.

34. A device comprising:
an instruction dispatcher configured to send an instruction to one or more of load data or store data;
an execution unit comprising a configuration table and a scheduler, wherein the execution unit is configured to:
receive the instruction;
determine a configuration identifier associated with the instruction;
determine, based on the configuration table and the configuration identifier, one or more configuration attributes; and
schedule, via the scheduler and based on the one or more configuration attributes, timing of performing the instruction; and
a register file configured to receive, based on at least the instruction, a request to perform a memory operation.

35. The device of claim 34, wherein the instruction comprises an opcode and one or more operands, wherein the opcode comprises an operation to perform and the one or more operands comprise the configuration identifier.

36. The device of claim 34, wherein the instruction dispatcher is configured to one or more of insert the configuration identifier in a field of the instruction or send the configuration identifier with the instruction, and wherein the execution unit is configured determining the configuration identifier by accessing the configuration identifier in the field of the instruction or in data sent with the instruction.

37. The device of claim 34, wherein the one or more configuration attributes comprise one or more of a coalescing granularity, a coalescing threshold, a coalescing window, or a quality of service requirement.

38. The device of claim 34, wherein the one or more configuration attributes indicate an amount of data to one or more of load or store during a single memory operation.

39. The device of claim 34,. wherein the one or more configuration attributes indicate an efficiency for storing a useful data bits per total data bits.

40. The device of claim 34, wherein the one or more configuration attributes indicate a maximum number of cycles of delay for performing the instruction.

41. The device of claim 34,wherein the scheduler is configured to schedule timing of performing the instructions by one or more of scheduling a future time to perform the instruction, scheduling a period of delay, or delaying performing the instruction until a condition indicated in the one or more configuration attributes is satisfied.

42. The device of claim 34, wherein the execution unit comprises a load/store unit configured to load data and store data in the register file.

43. The device of claim 34, wherein the one or more configuration attributes configure the execution unit to group a plurality of instructions for loading or storing data as a single memory request to the register file.

44. The device of claim 34, wherein the one or more configuration attributes indicate latency and bandwidth requirements for memory register access.

45. The device of claim 34, wherein the configuration table is reconfigurable to one or more of add a new identifier and corresponding configuration attributes, remove an identifier and corresponding configuration attributes, or change a configuration attribute associated with an identifier.

46. A system comprising:
a processor; and
an instruction dispatcher, an execution unit, and a register file according to claim 34.

47. A system comprising:
a plurality of processing units configured to perform the method of claim 21.

48. The system of claim 47, wherein the plurality of processing units are distributed among one or more of: a plurality of separate computing devices, a plurality of geographically distributed devices, a plurality of server blades, a plurality of server racks, a plurality of server locations.

49. The system of claim 47,wherein the system is configured to distribute data processing loads among the plurality of processing unit.

50. The system of claim 49,wherein the data processing loads comprise loads for one or more of a cognitive search service, an artificial intelligence service, or a network based data analysis service.

51. A method comprising:
generating, by a processing unit, an instruction for a register file associated with the processing unit;
sending the instruction to a first port of the register file;
performing, based on the instruction and logic associated with the first port, a plurality of operations; and
causing, based on one or more results of the plurality of operations, an update to the register file.

52. The method of claim 51, wherein the plurality of operations comprises a first operation and a second operation dependent on a result of the first operation.

53. The method of claim 52, wherein the first operation is based on logic coupled to the first port and data from the register file.

54. The method of claim 51, wherein the plurality of operations are performed in a single memory read/write cycle.

55. The method of claim 51, wherein the logic associated with the first port comprises reconfigured logic configured to perform the plurality of operations.

56. The method of claim 51, wherein the register file comprises the first port and a second port, wherein the first port provides data to a first operation and the second port is provides data to a second operation different than the first operation.

57. The method of claim 51, wherein the register file comprises a plurality of addressable memory locations.

58. The method of claim 51, wherein the processing unit comprises one or more of a central processing unit, a tensor processing unit, or a graphics processing unit.

59. The method of claim 51, wherein the one or more results comprise a multidimensional result matrix.

60. The method of claim 51, wherein the plurality of operations comprises one or more of updating ordering of a queue stored in the register file, sorting an array of values stored in the register file, an operation dependent on another operation in the plurality of operations, or an operation having an input size different than an output size.

61. The method of claim 51, wherein the plurality of operations implements one or more of an artificial intelligence-based search or a cognitive search.

62. The method of claim 51, wherein the register file is a component of the processing unit.

63. The method of claim 51, wherein sending the instructions indicate a data value, a memory address of the register file, and the first input.

64. The method of claim 51, further comprising determining, based on a context associated with the instruction, which input of a plurality of inputs of the register file to send the instructions, wherein the first input is select based on the first input matching the context.

65. The method of claim 51, wherein the plurality of operations are performed in the register file.

66. The method of claim 51, wherein the logic associated with the first input comprises logic comprised in the register file.

67. The method of claim 51, further comprising sending an additional instruction to a third input, wherein the third input causes a memory value to be one or more of accessed or updated without performing logic operations.

68. The method of claim 51, wherein causing the update to the register file comprises causing, based on the instruction, a plurality of updates to a plurality of data values stored in the register file.

69. A device comprising:
a processing unit; and
a register file in communication with the processing unit and configured to perform the methods of claim 51.

70. A non-transitory computer-readable medium storing instructions that, when executed by one or more processors, cause a device to perform the method of claim 51.

71. A system comprising;
a first device configured to send data via a network; and
a second device configured to receive the data via the network and perform, based on the data, the method of claim 51.

72. A computational register file, comprising:
a plurality of input ports comprising a first input port and a second input port;
a plurality of logic units comprising a first logic unit and a second logic unit, wherein the first logic unit is communicatively coupled to the first input port and configured to perform a first plurality of operations, and wherein the second logic unit is communicatively coupled to the second input port; and
a register file communicatively coupled to the plurality of logic units,
wherein at least a portion of the plurality of input ports are configured to receive instructions for the register file and supply the instructions to a corresponding logic unit of the plurality of logic units, which performs a sequence of corresponding operations programmed into the logic unit to data and applies the result of the sequence of operations to the register file.

73. The computational register file of claim 72, wherein the plurality of logic units are programmable.

74. The computational register file of claim 72, wherein the first logic unit is configured to receive a memory command, access data from the register file based on the memory command, perform the plurality of operations on the data, and cause the register file to store a result of the plurality of operations.

75. The computational register file of claim 72, wherein the plurality of input ports comprises a third input port communicatively coupled to the register file without being coupled to any of the plurality of logic units.

76. The computational register file of claim 72, wherein the computational register file is configured to perform any of the actions and/or include any of the features of claim 51.
